(19) United States
(12) Patent Application Publication
(10) Pub. No.: US 2015/0171966 A1
(43) Pub. Date: Jun. 18, 2015

(54) REGENERATOR PLACEMENT USING A POLYNOMIAL-TIME ALGORITHM

(71) Applicant: International Business Machines Corporation, Armonk, NY (US)

(72) Inventor: Mariusz A. Rokicki, Marki (PL)

(73) Assignee: International Business Machines Corporation, Armonk, NY (US)

(21) Appl. No.: 14/107,064

(22) Filed: Dec. 16, 2013

(51) Int. Cl. H04B 10/29; H04B 10/079; H04B 10/2513

(52) U.S. Cl. CPC H04B 10/29; H04B 10/2513; H04B 10/07951; H04B 10/07953

(57) ABSTRACT

One or more processors receives data that includes a plurality of light paths of an optical network. The one or more processors partition the plurality of light paths into a plurality of abutting segments such that a given pair of abutting segments have a combined length of, at most, a maximum distance a signal can travel in the light path of the pair before the signal suffers one or both of dispersion and attenuation in excess of a threshold. The One or more processors determine optical regenerator placement in the optical network using a first polynomial-time algorithm. The placement optical regenerators in the network is based, at least in part, on the partitioning.

### FIELD OF THE INVENTION

The present invention relates generally to the field of optical networking, and more particularly to regenerator placement in optical networks.

### BACKGROUND OF THE INVENTION

Fiber-optic communication is a method of transmitting information from one place to another by sending pulses of light through an optical fiber. The light forms an electromagnetic carrier wave that is modulated to carry information. First developed in the 1970s, fiber-optic communication systems have revolutionized the telecommunications industry and have played a major role in the advent of the Information Age. As a result of advantages over electrical transmission, optical fibers have, in many instances, replaced copper wire communications in core networks in the developed world.

The process of communicating using fiber-optics involves the following basic steps: Creating the optical signal involving the use of a transmitter, relaying the signal along the fiber, ensuring that the signal does not become too distorted or weak, receiving the optical signal, and converting it into an electrical signal.

When a communications link must span a larger distance than existing fiber-optic technology is capable of, the signal must be regenerated at intermediate points in the link by optical communications regenerators, which are also known as repeaters. Regenerators can add substantial cost to a communication system, and as such, system designers often attempt to minimize their use.

### SUMMARY

Embodiments of the present invention provide a method, system, and program product to determine regenerator placement in optical networks. One or more processors receive data that includes a plurality of light paths of an optical network. The one or more processors partition the plurality of light paths into a plurality of abutting segments, such that a given pair of the plurality of abutting segments has a combined length of, at most, a maximum distance a signal can travel in a light path corresponding to the pair before the signal suffers one or both of dispersion and attenuation in excess of a threshold. The one or more processors determine optical regenerator placement in the optical network using a first polynomial-time algorithm. The placement of the optical regenerators in the optical network is based, at least in part, on the partitioning.

### BRIEF DESCRIPTION OF THE SEVERAL VIEWS OF THE DRAWINGS

FIG. 1 is a functional block diagram illustrating an optical networking environment, in accordance with an exemplary embodiment of the present invention.

FIG. 2 illustrates the processes executed by a regenerator placement program, operating on a computing device within the environment of FIG. 1, in accordance with an exemplary embodiment of the present invention.

FIGS. 3-5 illustrate an example of a bipartite graphing scenario using the polynomial-time algorithm, in accordance with an exemplary embodiment of the present invention.

FIG. 6 depicts a block diagram of components of the computing device executing the regenerator placement program, in accordance with an exemplary embodiment of the present invention.

### DETAILED DESCRIPTION

In computer science, the time complexity of an algorithm quantifies the amount of time taken by an algorithm to run as a function of the length of the string of data representing the input. The time complexity of an algorithm is commonly expressed using big 0 notation, which excludes coefficients and lower order terms. When expressed this way, the time complexity is said to be described asymptotically, i.e., the time complexity increases as the input size goes to infinity. For example, if the time required by an algorithm on all inputs of size n is at most 5n³+3n, the asymptotic time complexity is O(n³).

Time complexity is commonly estimated by counting the number of elementary operations performed by the algorithm, where an elementary operation takes a fixed amount of time to perform. Thus, the amount of time taken and the number of elementary operations performed by the algorithm differ by at most a constant factor. Since an algorithm's performance time may vary with different inputs of the same size, one commonly uses the worst-case time complexity of an algorithm, denoted as T(n), which is defined as the maximum amount of time taken on any input of size n. Time complexities are classified by the nature of the function T(n). For example, an algorithm with T(n)=0(n) is called a linear time algorithm, and an algorithm with T(n)=0(2ⁿ) is said to be an exponential time algorithm. An algorithm is said to be of polynomial time if its running time is upper bounded by a polynomial expression in the size of the input for the algorithm, i.e., T(n)=0(n^{k}) for some constant k.

While known solutions to regenerator placement in optical networks are known, they are often based on exponential-time. A solution to regenerator placement using polynomial time would have the advantage of speed, i.e., it would be faster to solve a regenerator placement problem using a polynomial-time algorithm than an exponential-time algorithm. Even if given a known exponential-time algorithm to solve for regenerator placement, there is no known method to simply convert such an algorithm into a polynomial-time algorithm.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device. It is to be noted that computer-readable storage media herein comprise all computer-readable media, with the sole exception being a transitory, propagating signal.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk®, C++ or the like and conventional procedural programming languages, such as the “C” programming language or similar programming languages (note: the term(s) “Java”, “Smalltalk” and the like may be subject to trademark rights in various jurisdictions throughout the world and are used here only in reference to the products or services properly denominated by the marks to the extent that such trademark rights may exist). The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

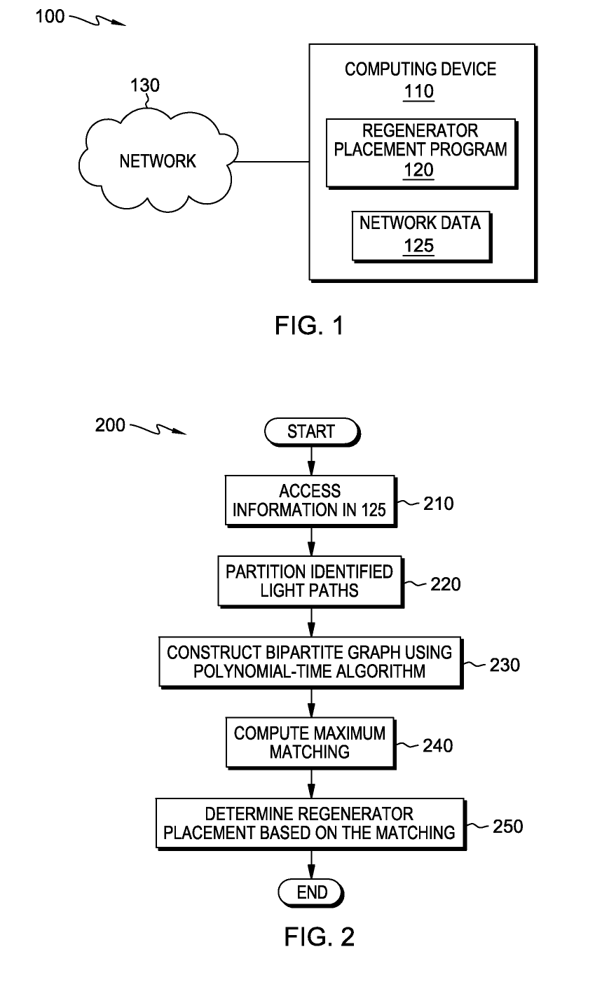

The present invention will now be described in detail with reference to the Figures. FIG. 1 is a functional block diagram illustrating an optical networking environment, generally designated 100, in accordance with one embodiment of the present invention. Optical networking environment 100 includes computing device 110. Computing device 110 includes regenerator placement program 120 and network data 125.

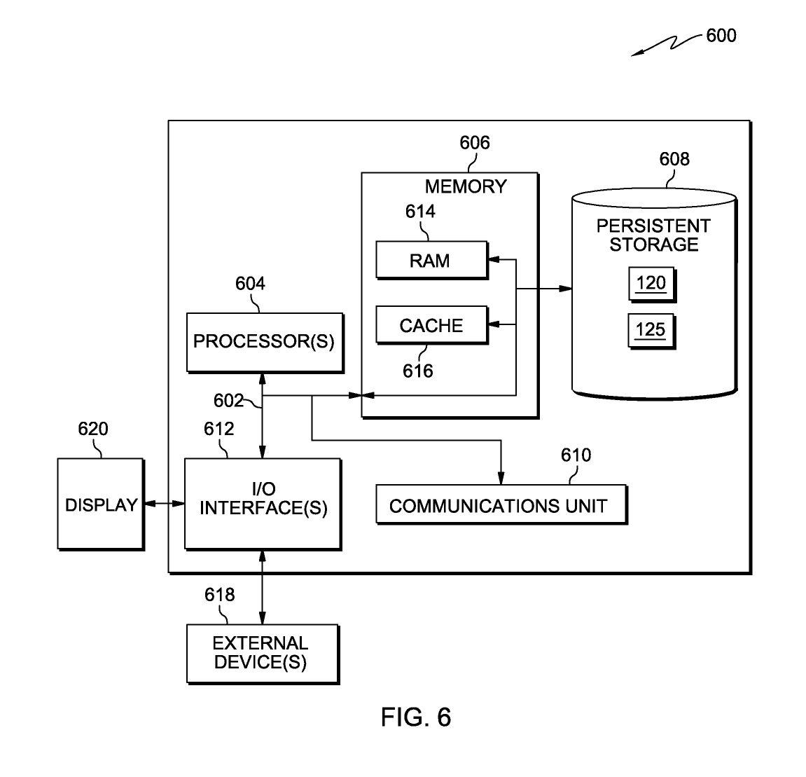

In various embodiments of the present invention, computing device 110 is a computing device that can be a standalone device, a server, a laptop computer, a tablet computer, a netbook computer, a personal computer (PC), or a desktop computer. In another embodiment, computing device 110 represents a computing system utilizing clustered computers and components to act as a single pool of seamless resources. In general, computing device 110 can be any computing device or a combination of devices with access to regenerator placement program 120 and network data 125 and is capable of executing regenerator placement program 120. Computing device 110 may include internal and external hardware components, as depicted and described in further detail with respect to FIG. 6.

In this exemplary embodiment, regenerator placement program 120 and network data 125 are stored on computing device 110. However, in other embodiments, regenerator placement program 120 and network data 125 may be stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between computing device 110, regenerator placement program 120 and network data 125, in accordance with a desired embodiment of the present invention.

In exemplary embodiments, network data 125 includes information describing the nodes of the optical network (hereinafter N), the light paths between nodes (hereinafter P), the maximum number of regenerators that can be placed in a node (hereinafter K), and the maximum number of hops (hereinafter D) a signal can travel in a light path before it suffers an unacceptable degree of dispersion or attenuation. A hop herein represents one portion of the path between the source of a signal and the destination of the signal. When communicating over the Internet, for example, data passes through a number of intermediate devices (like routers) rather than flowing directly over a single wire. Each such device causes data to “hop” between one point-to-point network connection and another point-to-point network connection.

In exemplary embodiments, regenerator placement program 120 uses the information in network data 125 to determine regenerator placement in an optical network. In the field of graph theory, a bipartite graph (or bigraph) is a graph whose vertices can be divided into two disjoint sets such that every edge connects a vertex in one set to a vertex in the other set. Regenerator placement program 120 utilizes a polynomial-time algorithm for computing maximum matching algorithms applied to bipartite graphs, and a polynomial-time algorithm to determine regenerator placement in an optical network. “Maximum matching” is a matching that contains the largest possible number of edges. The computed matching is mapped to regenerator placement, which is then included as part of the information included in network data 125.

The input for regenerator placement program 120 can be visualized as a symmetric graph representing topology of the optical network. For example, the input for regenerator placement program 120 is symmetric graph G(V,E). In the graph G(V,E), each light path is represented as a simple path in graph G and each node is shared by at most DK/2 light paths (P). The regenerators are placed such that each path is satisfied and each node stores at most K regenerators. The output of regenerator placement program 120 is regenerator placement within the optical network.

In mathematics, a lemma or helping theorem is a proven proposition which is used as a stepping stone to a larger result rather than as a statement of interest by itself. In other words, a lemma is a subsidiary proposition assumed to be valid and is used to demonstrate a principal proposition, which, in this case, is that the polynomial-time algorithm can and will generate a valid solution for regenerator placement in the optical network. The lemma for the polynomial-time algorithm used by regenerator placement program 120 is as follows: (i) There are m light paths {P_{—}1, . . . , P_m} given to be satisfied on graph G=(V,E). (ii) Assume that K=1 and D=>1. If each node v in V is shared by at most D/2 light paths, then all the paths can be satisfied. More over, the solution can be computed in polynomial time.

The proof for the polynomial-time algorithm used by regenerator placement program 120 is as follows: (a) partition each light path P_i, for i=1 . . . m, into consecutive blocks of length D/2. More precisely, each path P_i is partitioned into consecutive blocks, each block contains exactly D/2 nodes. If the last block of the path does not contain exactly D/2 nodes then such a block is excluded from our consideration. (b) Observe that if a regenerator can be placed in each block of each path, then all paths will be satisfied. This is because each path will have a distance between any two consecutive regenerators of at most D. Of course, in some embodiments, it may be the case that regenerators are placed more densely since the shortest distance between any two consecutive regenerators is D/2. (c) Construct the following bipartite graph B(V1, V2) according to the following: For each block in light path P_i, for i=1 . . . m, create a node in V_{—}1. For each node v in V we create a node in V_{—}2. There is an edge between node u in V_{—}1 (representing a block of a path) and node v in V_{—}2 if and only if (iff) node v belongs to the block represented by node u.

It can now be observed that the degree of each node in V1 is exactly D/2, since there are exactly D/2 nodes in each block, and that the degree of each node in V_{—}2 is at most D/2 since each node is shared by at most D/2 paths by our assumption. A relationship can be generated between satisfying of all the paths and matching problem in the bipartite graph. If the matching of size |V1| in the bipartite graph B(V_{—}1,V_{—}2) is computed, then all the paths of the graph can be satisfied. More precisely, matching in the bipartite graph B(V_{—}1,V_{—}2) guarantees that each block of each light path gets assigned exactly one node for its regenerator and this node cannot be shared with any other block. Next, it can be justified that a matching of size |V1| exists in the bipartite graph. More precisely, it can be shown that the constructed bipartite graph meets condition of the Hall's theorem. For example, consider a subset of nodes S of V1 and compute the size of its neighborhood N(S). If |N(S)|=>|S|, then the condition of the Hall's theorem is met. Since each node u in V1 is adjacent to exactly D/2 nodes in V_{—}2 and each node in V2 is of degree at most D/2, by assumption, then N(S)=>(|S| (d/2))/D/2=|S|. Thus, by Hall's theorem the matching of size exactly |V_{—}1| can be found. Therefore, each block gets assigned exactly one regenerator, which implies that all m light paths are satisfied.

The above described lemma implies that all the light paths can be satisfied provided each node is shared by at most K*D/2 light paths. To visualize this, K copies of each node are created and assume K=1. Next, the light paths traversing node V are uniformly distributed between the copies of node V such that each copy is shared by at most D/2 light paths. This approach yields a new graph, G, where K=1 and each node is shared by at most D/2 light paths. By applying the above described lemma, all the light paths can be satisfied.

FIG. 2 is a flow chart, 200, illustrating the processes utilized by regenerator placement program 120 to determine the optimal placement of regenerators in the optical network described by network data 125, in accordance with an exemplary embodiment.

In process 210, regenerator placement program 120 accesses the information included in network data 125. Regenerator placement program 120 identifies the nodes, number of regenerators per node, and number of light paths to connect to each node.

In process 220, regenerator placement program 120 partitions the identified light paths. To partition the light paths, regenerator placement program 120 creates K copies of each node, sets K=1 for each newly created node, i.e., the node copies, and distributes the light paths such that each new node is traversed by at most D/2 light paths. Such a distribution is possible since it has been assumed that each original node is shared by at most K*D/2 light paths and there are now K copies of the original node. Regenerator placement program 120 partitions the light paths to create abutting segments with respective lengths of at most D/2. This ensures that when regenerators are placed into the segments the distance between regenerators will be at most D, i.e., D/2+D/2=D.

In process 230, regenerator placement program 120 constructs a bipartite graph using the polynomial-time algorithm. Regenerator placement program 120 uses the nodes, number of regenerators per node, and number of light paths to connect to each node, which are now segmented into lengths of D/2, and the polynomial-time algorithm to construct the bipartite graph. In this embodiment, in a constructed bipartite graph, the nodes are represented as vertices and the light paths are represented as edges connecting those nodes.

Then, in process 240, regenerator placement program 120 computes the maximum matching for the bipartite graph using a maximum matching algorithm. In process 250, regenerator placement program 120 determines the placement of regenerators based on the results of the maximum matching. The determined placement of regenerators can then be used to determine the configuration of the optical network.

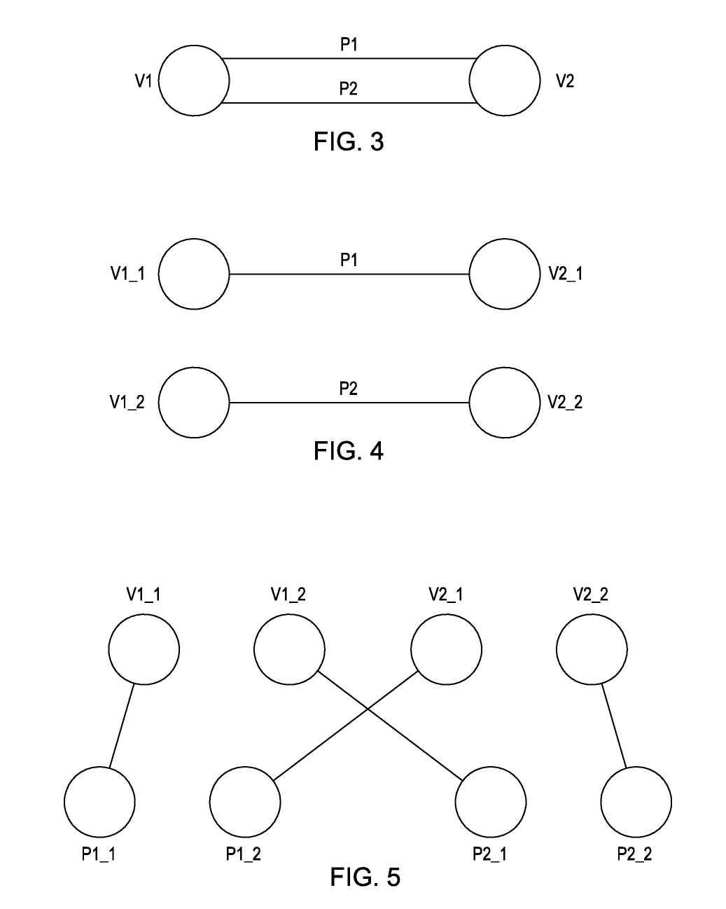

FIGS. 3-5 illustrate an example of a bipartite graphing scenario using the polynomial-time algorithm. As shown in FIG. 3, this example includes only two nodes (V1 and V2) and two paths (P1 and P2), which is a simplified example of an optical network. In this example there are only 2 regenerators per node, i.e., K=2 and D=2. Since K=2 the nodes are copied and the paths are split such that each path traverses exactly one node, as shown in FIG. 4. To differentiate the node splitting, additional identifiers are added to the nodes. Node V1 yields nodes V1_{—}1 and V1_{—}2, and node V2 yields nodes V2_{—}1 and V2_{—}2.

FIG. 5 illustrates the final bipartite graph generated using the polynomial-time algorithm. As shown in FIG. 5, the pathways are denoted along with the node to which they are connected. For example, nodes V1_{—}2 and V2_{—}2 are connected to pathway P2 in FIG. 4. As such, in FIG. 5, there are two instances of pathway P2 which are differentiated from each other by the inclusion of another identifier, yielding P2_{—}1 and P2_{—}2. The same treatment is used to differentiate the instances of pathway P1.

FIG. 5 illustrates a perfect matching scenario and, as such, use of a perfect matching algorithm is not required. The resulting regenerator placement, in an optical network, based on FIG. 5 is as follows: (i) light path P1 is assigned two regenerators, one in each of nodes V1 and V2, and (ii) light path P2 is assigned two regenerators, one in each of nodes V1 and V2. Since the regenerator capacity of the nodes is K=2 and each node is assigned 2 regenerators, the solution is valid.

In some embodiments, if the network topology changes significantly over time, e.g., the network expands, and then the regenerator placement will have to be recomputed.

In certain instances the bipartite graph and matching algorithm can be used to verify if a legitimate solution exists for a given set of light paths. More precisely, each network node is replicated K times and the light paths traversing the node are uniformly distributed between the copies of the node. Each light path is partitioned into consecutive blocks of length D. Each block represents a node in the first layer of the bipartite graph. The second layer of the nodes in the bipartite graph is represented by network nodes. Each network node is replicated K times. If a network node v is contained in the block u, then edges are created between block node u in the first layer and k copies of network node v in the second layer.

In the exemplary embodiment, a legitimate solution should guarantee that there is a regenerator placed in each block (of length D). In such a scenario, a perfect matching in the bipartite graph would have each block with an assigned copy of a network node, where its regenerator is placed. The perfect matching properties guarantees that each node in the network stores at most K regenerators. So, if the perfect matching exists, then the legitimate solution for a given set of paths can exist. Otherwise, if the perfect matching does not exist, then a legitimate solution does not exist.

FIG. 6 depicts a block diagram, 600, of components of computing device 110, in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

Computing device 110 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer-readable storage media. In this embodiment, memory 606 includes random access memory (RAM) 614 and cache memory 616. In general, memory 606 can include any suitable volatile or non-volatile computer-readable storage media.

Regenerator placement program 120 and network data 125 are stored in persistent storage 608 for execution and/or access by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer-readable storage medium that is also part of persistent storage 608.

Communications unit 610, in these examples, provides for communications with other data processing systems or devices, including resources of network 130. In these examples, communications unit 610 includes one or more network interface cards. Communications unit 610 may provide communications through the use of either or both physical and wireless communications links. Regenerator placement program 120 and network data 125 may be downloaded to persistent storage 608 through communications unit 610.

I/O interface(s) 612 allows for input and output of data with other devices that may be connected to computing device 110. For example, I/O interface 612 may provide a connection to external devices 618 such as a keyboard, keypad, a touch screen, and/or some other suitable input device. External devices 618 can also include portable computer-readable storage media such as, for example, thumb drives, portable optical or magnetic disks, and memory cards. Software and data used to practice embodiments of the present invention, e.g., regenerator placement program 120 and network data 125, can be stored on such portable computer-readable storage media and can be loaded onto persistent storage 608 via I/O interface(s) 612. I/O interface(s) 612 also connect to a display 620.

Display 620 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1-7. (canceled)

8. A computer program product for determining optical regenerator placement, the computer program product comprising:
one or more computer-readable storage media and program instructions stored on the one or more computer-readable storage media, the program instructions comprising:
program instructions to receive data that includes a plurality of light paths of an optical network;
program instructions to partition the plurality of light paths into a plurality of abutting segments, wherein a given pair of the plurality of abutting segments have a combined length of, at most, a maximum distance a signal can travel in a light path corresponding to the pair before the signal suffers one or both of dispersion and attenuation in excess of a threshold; and
program instructions to determine optical regenerator placement in the optical network using a first polynomial-time algorithm, wherein the placement is based, at least in part, on the partitioning.

9. The computer program product of claim 8, wherein the data further includes information describing two or more nodes of the optical network, respective light paths between those nodes, and a maximum number of regenerators that can be placed in a given node.

10. The computer program product of claim 9, wherein a solution for regenerator placement in the optical network includes each node being shared by a number of light paths equal to, at most, one half the product of (i) the maximum number of regenerators that can be placed in a given node of the optical network and (ii) the maximum number of hops a signal can travel in a given light path before the signal suffers one or both of dispersion and attenuation in excess of a threshold.

11. The computer program product of claim 9, wherein the program instructions to partition the light paths into abutting segments include:
program instructions to generate a data representation of each node of the optical network; and
program instructions to generate a number of copies of a given data representation, wherein the number of generated copies of that given data representation is equal to the maximum number of regenerators that can be placed in the corresponding node of that given data representation.

12. The computer program product of claim 9, wherein the program instructions to partition the light paths into abutting segments include:
program instructions to distribute the light paths such that each node is traversed by a number of light paths equal to, at most, one half the maximum number of hops a signal can travel in a given light path before the signal suffers one or both of dispersion and attenuation in excess of a threshold.

13. The computer program product of claim 8, the program instructions further comprising:
program instructions to generate a bipartite graph; and
program instructions to compute a maximum matching for the bipartite graph utilizing a second polynomial-time algorithm, wherein the optical regenerator placement is based, at least in part, on the maximum matching.

14. The computer program product of claim 8, wherein at least one of the segments included in the pair of abutting segments has a length of, at most, one half of a maximum distance a signal can travel in a given light path before the signal suffers one or both of dispersion and attenuation in excess of a threshold.

15. A computer system for determining optical regenerator placement, the computer system comprising:
one or more computer processors;
one or more computer-readable storage media;
program instructions stored on the computer-readable storage media for execution by at least one of the one or more processors, the program instructions comprising:
program instructions to receive data that includes a plurality of light paths of an optical network;
program instructions to partition the plurality of light paths into a plurality of abutting segments, wherein a given pair of the plurality of abutting segments have a combined length of, at most, a maximum distance a signal can travel in a light path corresponding to the pair before the signal suffers one or both of dispersion and attenuation in excess of a threshold; and
program instructions to determine optical regenerator placement in the optical network using a first polynomial-time algorithm, wherein the placement is based, at least in part, on the partitioning.

16. The computer system of claim 15, wherein the data further includes information describing two or more nodes of the optical network, respective light paths between those nodes, and a maximum number of regenerators that can be placed in a given node.

17. The computer system of claim 15, wherein a solution for regenerator placement in the optical network includes each node being shared by a number of light paths equal to, at most, one half the product of (i) the maximum number of regenerators that can be placed in a given node of the optical network and (ii) the maximum number of hops a signal can travel in a given light path before the signal suffers one or both of dispersion and attenuation in excess of a threshold.

18. The computer system of claim 16, wherein the program instructions to partition the light paths into abutting segments include:
program instructions to generate a data representation of each node of the optical network; and
program instructions to generate a number of copies of a given data representation, wherein the number of generated copies of that given data representation is equal to the maximum number of regenerators that can be placed in the corresponding node of that given data representation.

19. The computer system of claim 16, wherein the program instructions to partition the light paths into abutting segments include:
program instructions to distribute the light paths such that each node is traversed by a number of light paths equal to, at most, one half the maximum number of hops a signal can travel in a given light path before the signal suffers one or both of dispersion and attenuation in excess of a threshold.

20. The computer system of claim 15, the program instructions further comprising:
program instructions to generate a bipartite graph; and
program instructions to compute a maximum matching for the bipartite graph utilizing a second polynomial-time algorithm, wherein the optical regenerator placement is based, at least in part, on the maximum matching.

21. The computer system of claim 15, wherein at least one of the segments included in the pair of abutting segments has a length of, at most, one half of a maximum distance a signal can travel in a given light path before the signal suffers one or both of dispersion and attenuation in excess of a threshold.
